(19) United States
(12) Patent Application Publication
(10) Pub. No.: US 2022/0326975 A1
(43) Pub. Date: Oct. 13, 2022

(54) TRANSPARENT DATA REDUCTION IN PRIVATE/PUBLIC CLOUD ENVIRONMENTS FOR HOST ENCRYPTED DATA

(71) Applicant: Lenovo Enterprise Solutions (Singapore) Pte. Ltd., Singapore (SG)

(72) Inventors: Bogdan Cosmin Chifor, Com. Nojorid (RO); Radu Mihai Iorga, Bucharest (RO); Corneliu-Ilie Calciu, Bucharest (RO); George-Andrei Stanescu, Popesti-Leordeni (RO)

(21) Appl. No.: 17/219,182

(22) Filed: Mar. 31, 2021

(51) Int. Cl. G06F 9/455; H04L 9/08; H04L 29/08

(52) U.S. Cl. CPC G06F 9/45558; G06F 9/45545; H04L 9/0897; H04L 9/0819; H04L 67/1097; G06F 2009/45587; G06F 2009/45595

(57) ABSTRACT

A processor may perform hypervisor operations including managing a virtual machine (VM), wherein the VM supports operation of a guest operating system and an application, managing a virtual trusted platform module (TPM), attaching the virtual TPM to the VM, and causing the virtual TPM to provide a session key to the application and a cloud storage application that controls data storage on one or more physical data storage device. A separate processor may perform cloud storage operations including receiving a session key from a virtual TPM and receiving first encrypted data from an application running in a VM. The operations may further include decrypting the first encrypted data using the session key, performing data reduction operations on the decrypted data to obtain compressed data, encrypting the compressed data using a storage encryption key to obtain second encrypted data, and causing the second encrypted data to be stored in data storage.

### BACKGROUND

The present disclosure relates to a manner of storing encrypted data in a cloud storage environment.

### BACKGROUND OF THE RELATED ART

A cloud storage application may be used to receive data from a virtual machine and store the data on a physical data storage device. The cloud storage application will often provide data-at-rest encryption to maintain a high level of security over the data that is stored on the physical data storage device. Data-at-rest encryption involves encrypting the data before storing the data on the physical data storage device. Accordingly, if the physical data storage device is possessed, copied or otherwise accessed by an unauthorized party, the encrypted data cannot be obtained without the appropriate encryption key.

A cloud storage application may also provide for one or more data reduction operations, such as data compression and deduplication. However, data reduction operations are typically executed before encrypting data and saving the data to the physical data storage device. The reason for performing data reduction operations before data encryption is that data reduction operations are most efficient on data with lots of repeating patterns. Encrypted data has a random pattern (high entropy) with few repeating patterns. Accordingly, performing data reduction on encrypted data provides very little benefit.

Virtual machines that run security-sensitive applications, such as Payment Card Industry (PCI) applications, General Data Protection Regulation (GDPR) applications, or Health Insurance Portability and Accountability Act (HIPAA) applications, may be required to encrypt the associated security-sensitive data before transmitting the data to a cloud storage application. In this manner, an unauthorized part that intercepts the transmission will be unable to read the encrypted data without the appropriate encryption key. So, security-sensitive applications may perform data-at-rest encryption processes within the virtual machine virtual disk in order to reduce the risks of data breaches resulting from third party access to the virtual machine disk. For example, when an application is run on a virtual machine within a cloud computing system, the virtual machine disk may be fully managed by the cloud computing system. To avoid reliance upon the cloud computing system administrator to secure the virtual machine disk, data that is to be stored on the virtual machine may be encrypted within the virtual machine before the data even reaches the virtual machine disk. Unfortunately, applications that perform data-at-rest encryption within the virtual machine are unable to achieve any significant benefit from data reduction operations, because these applications transmit their data to cloud storage in a form that is already encrypted.

### BRIEF SUMMARY

Some embodiments provide a computer program product comprising a non-volatile computer readable medium and non-transitory program instructions embodied therein, the program instructions being configured to be executable by a processor to cause the processor to perform various operations. The operations may comprise managing a virtual machine, wherein the virtual machine supports operation of a guest operating system and an application running on the guest operating system, managing a virtual trusted platform module, attaching the virtual trusted platform module to the virtual machine, and causing the virtual trusted platform module to provide a session key to the application and to a cloud storage application that controls data storage on one or more physical data storage devices.

Some embodiments provide a computer program product comprising a non-volatile computer readable medium and non-transitory program instructions embodied therein, the program instructions being configured to be executable by a processor to cause the processor to perform various operations. The operations may comprise receiving a session key from a virtual trusted platform module and receiving first encrypted data from an application running in a virtual machine, wherein the first encrypted data has been encrypted with the session key. The operations may further comprise decrypting the first encrypted data received from the application using the session key received from the virtual trusted platform module, performing one or more data reduction operations on the decrypted data to obtain compressed data, and encrypting the compressed data using a storage encryption key to obtain second encrypted data, wherein the second encrypted data includes fewer bytes than the first encrypted data. Still further, the operations may comprise causing the second encrypted data to be stored on a physical data storage device.

Some embodiments provide a method comprising managing a virtual machine, wherein the virtual machine supports operation of a guest operating system and an application running on the guest operating system, managing a virtual trusted platform module, attaching the virtual trusted platform module to the virtual machine, and causing the virtual trusted platform module to provide a session key to the application and to a cloud storage application that controls data storage on one or more physical data storage devices.

### BRIEF DESCRIPTION OF THE SEVERAL VIEWS OF THE DRAWINGS

FIG. 1 is a diagram of a virtualization environment including a hypervisor in communication with a cloud storage application for storing application data on physical data storage media.

FIG. 2A is a flowchart of a process for storing data that has been encrypted by a virtual machine on physical data storage media with the benefit of data reduction operations.

FIG. 2B is a flowchart of a process for reading encrypted data from the physical data storage media and reversing the data reduction operations before returning encrypted data to the virtual machine.

FIG. 3 is a flowchart of a process by which the virtual TPM handles the session key for the virtual machine application.

FIG. 4 is a diagram of a data storage device that runs a cloud storage application and stores encrypted data.

FIG. 5 is a diagram of a computer that is representative of a server running a hypervisor that supports a virtual machine.

### DETAILED DESCRIPTION

Some embodiments provide a computer program product comprising a non-volatile computer readable medium and non-transitory program instructions embodied therein, the program instructions being configured to be executable by a processor to cause the processor to perform various operations. The operations may comprise managing a virtual machine, wherein the virtual machine supports operation of a guest operating system and an application running on the guest operating system, managing a virtual trusted platform module, attaching the virtual trusted platform module to the virtual machine, and causing the virtual trusted platform module to provide a session key to the application and to a cloud storage application that controls data storage on one or more physical data storage devices.

In some embodiments, the computer program product may be a hypervisor and/or include a hypervisor or hypervisor functionality. A hypervisor may also be referred to as a virtual machine monitor or virtualizer. A hypervisor includes program instructions that create and run one or more virtual machine, present a guest operating system with a virtual operating platform, and manage the operation of the guest operating system. The hypervisor runs on a computer that may be referred to as a host machine and the virtual machine may be referred to as a guest machine.

Some embodiments provide a hypervisor that runs a virtual trusted platform module (virtual TPM). The virtual TPM is a module of the hypervisor. The virtual TPM appears to the virtual machine as if the virtual machine were attached to a physical TPM storing the data-at-rest encryption keys. For example, the hypervisor may expose the virtual TPM to the virtual machine by emulating a physical TPM. Accordingly, the virtual machine may access the virtual TPM (software based) to obtain a data-at-rest encryption key, referred to also as a session key. The virtual machine may, for example, access the virtual TPM using a virtual implementation of a physical hardware protocol, such as Peripheral Component Interconnect (PCI) or Inter-Integrated Circuit (I2C). The virtual TPM may assign a session key to the application. In one option, the virtual TPM may also generate and store a process identifier to be associated with the password and the session key. The virtual TPM may store the process identifier, password and session key in encrypted or unencrypted form. For example, the virtual machine may store this information in a physical TPM that is part of the server running the hypervisor.

In one option, there may be a virtual TPM for each virtual machine. In another option, a virtual TPM may be shared by all the virtual machines on the same hypervisor. Embodiments of the virtual TPM may provide a session key that enables an application running on a virtual machine to encrypt data-at-rest without modification of the application. Accordingly, the application may interface with the virtual TPM to obtain a session key in a transparent manner using the application's legacy programming. For example, the application may use a software driver of the guest operating system to interface and communicate with the virtual TPM. In some embodiments, the virtual TPM does not need to authenticate the application since both the virtual TPM and the virtual machine that runs the application are managed by the hypervisor.

In some embodiments, the operations may further comprise provisioning the virtual machine and assigning the application and guest operating system to the virtual machine. For example, a remote client may submit an application to be run in a virtualization environment, such as a cloud computing system. The hypervisor on one of the computers, such as a server, is tasked with the responsibility of provisioning a virtual machine and assigning the application and a guest operating system to the virtual machine. In one option, the virtual trusted platform module may be attached to the virtual machine as an aspect of the provisioning or initial setup of the virtual machine. The virtual trusted platform module emulates a physical trusted platform module and is attached to the virtual machine so that the virtual machine can communicate with the virtual trusted platform module as disclosed herein.

In some embodiments, the operations may further comprise causing the virtual trusted platform module to communicate with the cloud storage application over a secure channel using a secure transport protocol that authenticates the cloud storage application. In one specific implementation, the virtual TPM may establish a key escrow arrangement with the cloud storage application such that the virtual TPM exports the session key to the cloud storage application in a secure manner. For example, the key can be exported from the virtual TPM to the cloud storage application using Key Management Interoperability Protocol (KMIP) or a Transport Layer Security (TLS) secure channel. The key export transport channel preferably provides confidentiality and authentication of the parties (hypervisor and cloud storage application). For instance, the session key may be exported from the virtual TPM to the cloud storage application using a TLS channel which mutually authenticates both the virtual TPM and the cloud storage application using digital certificates. The TLS channel may support a TLS session including mutual authentication of the cloud storage application and the virtual TPM. For example, the cloud storage application may have a server digital certificate and the virtual TPM may have a client digital certificate.

The digital certificates used in the mutual authentication may be distributed to the virtual TPM and the cloud storage application by a certificate authority, which may be a certificate authority controlled by the cloud platform that includes both the virtual TPM and the cloud storage application. In a cloud computing environment, an orchestration layer may manage the virtual machines and the cloud storage application. In some embodiments, the certificate authority may be part of the orchestration layer which has access to both the virtual TPM and the cloud storage application.

In some embodiments, the operations may further comprise causing the virtual trusted platform module to generate the session key and causing the virtual trusted platform module to store the session key that was generated. Generating the session key within the virtual trusted platform module has the benefit of increased security, since the session key is unknown to any entity except the virtual trusted platform module itself as well as the application and cloud storage application that receive the session key directly from the virtual trusted platform module. In one option, the virtual trusted platform module may encrypt the session key using a password received from the application prior to storing the session key or using a password that is generated by the virtual trusted platform module. In another option, the virtual trusted platform module may store the session key on a physical trusted platform module, where the session key may be stored in an encrypted or unencrypted form.

In one option, the virtual TPM may have a unique master encryption key that may be used to encrypt the session key for the storage disk encryption process and may then store the encrypted session key in a physical TPM on the server that is running the hypervisor. Accordingly, the virtual TPM may retrieve the encrypted session key from the physical TPM, decrypt the encrypted session key using the master encryption key, and provide the session key to the application and/or the cloud storage application. The application and/or cloud storage application may cache the encryption key during an ongoing session there between.

In another option, the virtual TPM may use its master encryption key to encrypt the password received from the storage disk encryption process and may then store the encrypted password in the physical TPM on the server that is running the hypervisor. Accordingly, the virtual TPM may retrieve the encrypted password from the physical TPM and decrypt the encrypted password using the master encryption key. For example, the virtual TPM may retrieve and decrypt the password in order to compare it with the password in a request received from the storage disk encryption process of the guest operating system on behalf of the application. The virtual TPM may then use the decrypted password in a determination of whether or not to provide the storage disk encryption process with the session key that was previously stored in association with the password. Specifically, a storage disk encryption process may send a message to the virtual TPM, where the message requests a session key and provides a password and application identifier. The virtual TPM may then retrieve the encrypted password associated with the application identifier, decrypt the retrieved password, and compare the retrieved password with the password received in the message from the storage disk encryption process. If the passwords match, then the virtual TPM determines that the identity of the storage disk encryption process and/or the application is authentic (i.e., authenticates the storage disk encryption process or the application for which the storage disk encryption process submitted the message).

In some embodiments that require a password for the virtual machine to access the session key, the virtual TPM may use the password to encrypt the session key. Accordingly, the session key may be stored in an encrypted form and can only be decrypted using the corresponding password. The virtual TPM may then provide the session key to a storage disk encryption process that has submitted the corresponding password and, preferably, also submitted the corresponding process or application identifier.

In one embodiment, the password originates with the application, such as by the application generating the password or the application receiving the password as input from a user. However, in another embodiment, the password originates with the virtual TPM and the application fetches or otherwise receives the password from the virtual TPM. In this later embodiment, user input is not required and modification of the application to include password generation is not required. For example, in response to booting the virtual machine, the application may read the password and the encrypted session key from the virtual TPM, then decrypt the session key using the password. The application may then mount the virtual disk for self-encryption using the session key, including providing the decrypted session key to the storage disk encryption process for subsequent use encrypting data from the application that is being stored on the cloud storage via the virtual disk. It should be recognized that if the virtual TPM has encrypted password with a master key, then the virtual TPM must decrypt the password before providing the password to the application.

In some embodiments, the operations may further comprise providing the virtual machine with a virtual disk, wherein the application and guest operating system running in the virtual machine direct data storage operations to the virtual disk. The operation may still further comprise causing the virtual disk to emulate a physical disk, wherein data storage operations directed to the virtual disk are redirected to the cloud storage application to be stored on the physical data storage device. For example, data that is directed from the application to the virtual disk may be forwarded to the cloud storage application for storage on a physical data storage device.

Once the cloud storage application has the session key for a given application, the cloud storage application may take action in response to a data storage command received from or on behalf of the application. Specifically, a data storage command will include data that has already been encrypted by the storage disk encryption process of the guest operating system using the session key. The cloud storage application may respond to the data storage command by decrypting the encrypted data using the session key received from the virtual TPM in association with the identified application, applying one or more data reduction operations on the decrypted data, and then encrypting the compressed data with a storage encryption key. For example, the storage encryption key may be a unique encryption key that is known only to the cloud storage application. After performing one or more data reduction operations on the data, the cloud storage application uses the storage encryption key to encrypt the compressed data that is subsequently stored on a physical data storage device. For example, the cloud storage application may use any disk encryption scheme or specification, such as an open-source Linux-based disk encryption specification like Linux Unified Key Setup (LUKS).

In some embodiments, the cloud storage application may internally generate a unique storage encryption key for each virtual machine disk. The cloud storage application may store and handle the storage encryption key(s) in various manners, such as by storing the storage encryption key within a data structure in association with a process identifier that identifies the source of the data, such as a virtual machine identifier or an application identifier. Alternatively, the cloud storage application may use a key management service or even a physical TPM to store the storage encryption key(s) in association with a process identifier or virtual disk identifier.

The cloud storage application may partition the data on the storage array into blocks and every block may be encrypted. When data from a certain block is being accessed (read) by the application, the cloud storage application may decrypt the entire block of stored data and reverse any data reduction operations that were performed on the data prior to encryption with the storage encryption key. Once the data has been restored to the decompressed form that was previously provided by the application for storage, the cloud storage application will encrypt the decompressed data with the session key and transmit the encrypted data to the application. Therefore, the application receives the encrypted data as if the cloud storage application had stored the encrypted data without any data reduction or other modification.

Some embodiments of the physical data storage may include an array of data storage devices. In one option, the physical data storage may implement data redundancy. In one non-limiting example, the physical data storage may include an array of data storage devices and a controller may distribute the encrypted data across the array of data storage devices in a manner consistent with any RAID (Redundant Array of Independent Disks) level. A selected RAID level may be used increase the reliability, availability, performance and/or capacity of the physical data storage. Optionally, the cloud storage application may include the program instructions necessary to implement the RAID storage of the data.

Some embodiments provide the technical advantage of enabling data reduction operations to be applied to data that has already been encrypted by the guest operating system within the virtual machine. These data reduction operations may be performed in a manner that is transparent to the application and the guest operating system running on the virtual machine. Furthermore, this may be accomplished without requiring any modification of either the application or the virtual machine guest operating system. The disk encryption process of a typical application and/or guest operation system already looks for a TPM in order to retrieve a session key for use by the disk encryption process. The application running in the virtual machine may communicate with the virtual TPM in the same manner the application would communicate with a physical TPM and, therefore, the application does not require modification. For example, the application may communicate with the virtual TPM using a software driver that is a module of the guest operating system. Furthermore, the data that is being stored by the application is transported securely (encrypted with the session key) from the virtual machine to the cloud storage application and physical data storage device or array.

Some embodiments provide a computer program product comprising a non-volatile computer readable medium and non-transitory program instructions embodied therein, the program instructions being configured to be executable by a processor to cause the processor to perform various operations. The operations may comprise receiving a session key from a virtual trusted platform module and receiving first encrypted data from an application running in a virtual machine, wherein the first encrypted data has been encrypted with the session key. The operations may further comprise decrypting the first encrypted data received from the application using the session key received from the virtual trusted platform module, performing one or more data reduction operations on the decrypted data to obtain compressed data, and encrypting the compressed data using a storage encryption key to obtain second encrypted data, wherein the second encrypted data includes fewer bytes than the first encrypted data. Still further, the operations may comprise causing the second encrypted data to be stored on a physical data storage device. The foregoing processor may be a component of a storage controller or computer that runs a cloud storage application, and the program instructions may be included in the cloud storage application.

In some embodiments, the operations (of the cloud storage application) may further comprise communicating with the virtual trusted platform module over a secure channel using a secure transport protocol that authenticates the virtual trusted platform module, wherein the session key is received from the virtual trusted platform module over the secure channel. For example, the secure channel between the cloud storage application and the virtual trusted platform module may be established using Key Management Interoperability Protocol (KMIP) or Transport Layer Security (TLS).

In some embodiments, the operations (of the cloud storage application) may further comprise receiving a request from the application to read the first encrypted data, reading the second encrypted data stored on the physical data storage device, decrypting the second encrypted data using the storage encryption key to obtain the compressed data, decompressing the compressed data to obtain decompressed data, encrypting the decompressed data using the session key to obtain the first encrypted data, and sending the first encrypted data to the application in response to the received request.

In some embodiments, during a data storage (write) operation, the storage disk encryption process may use the session key to encrypt data before transmitting the encrypted data to the cloud storage application. The cloud storage application may then complete the data storage operation by decrypting the data received from the storage disk encryption process using the session key, performing one or more data reduction operations on the decrypted data, and then encrypting the compressed data using a storage encryption key before storing the encrypted data on the physical data storage device. Conversely, during a data retrieval (read) operation, the cloud storage application may use the storage encryption key to decrypt the encrypted data from the physical data storage device, reverse the previously performed one or more data reduction operations on the decrypted data (i.e., data decompression), and then use the session key to encrypt the data before transmitting the encrypted data to the virtual machine.

The one or more data reduction operations may include, without limitation, data compression and data deduplication. For example, data compression may include any operation that identifies redundant data inside an individual file and encodes the redundant data more efficiently. Data deduplication may include any operation that eliminates duplicate copies of repeating data, such as duplicate files or large sections of files, by replacing the duplicate copy with a reference to a shared copy.

Some embodiments provide an improvement in technology, such as an improvement in the operation of a computer. For example, some embodiments facilitate the benefits of data compression by a cloud storage application prior to data storage despite receiving data that was already encrypted within the virtual machine. Furthermore, some embodiments provide a combination of benefits, including improved security by transmitting and storing data in an encrypted form and improved data storage efficiency by compressing the data, with the necessity of modifying the application or the storage disk encryption process of the guest operating system. Some embodiments may accomplish these improvements without the application or guest operating system even being aware that the cloud storage application is performing data compression or any steps other than data storage. Furthermore, it is not necessary for the application or the storage disk encryption process to be modified or to even be aware that the virtual TPM is exporting the session key to the cloud storage application. In fact, the storage disk encryption process may operate as though the cloud storage application is merely storing the data as encrypted by the storage disk encryption process, even though the cloud storage application is performing additional operations. Accordingly, the decryption operations (using the session key), data reduction operations, and re-encryption operations (using the storage encryption key) performed by the cloud storage application during data storage are transparent to the virtual machine. Similarly, the decryption operations (using the storage encryption key), data decompression operations (reversing the data reduction operations), and re-encryption operations (using the session key) performed by the cloud storage application in response to a data request from the virtual machine are transparent to the virtual machine.

Some embodiments provide a method comprising managing a virtual machine, wherein the virtual machine supports operation of a guest operating system and an application running on the guest operating system, managing a virtual trusted platform module, attaching the virtual trusted platform module to the virtual machine, and causing the virtual trusted platform module to provide a session key to the application and to a cloud storage application that controls data storage on one or more physical data storage devices.

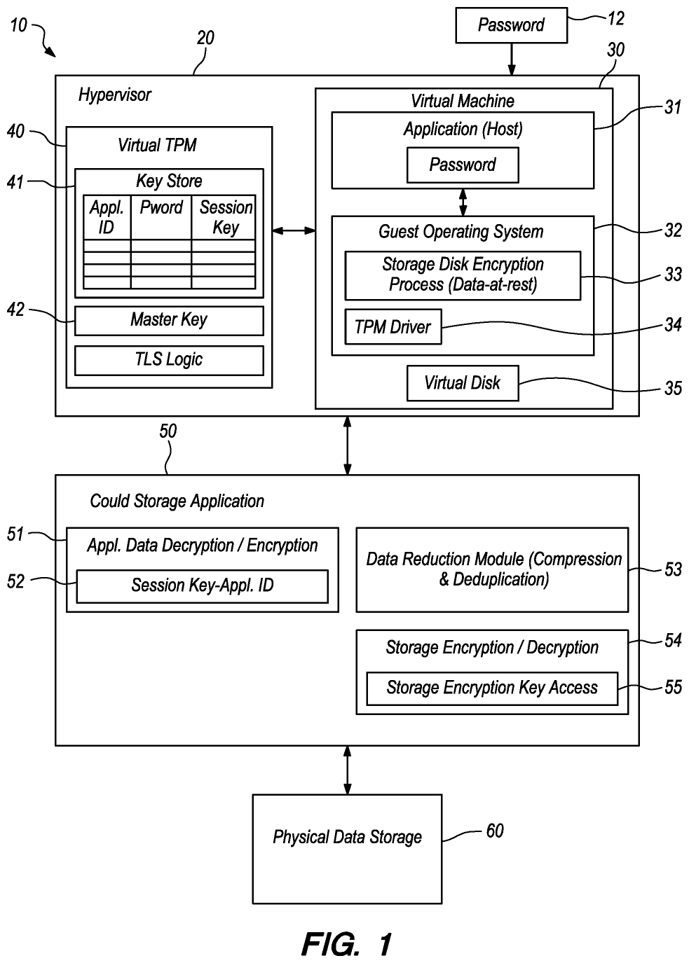

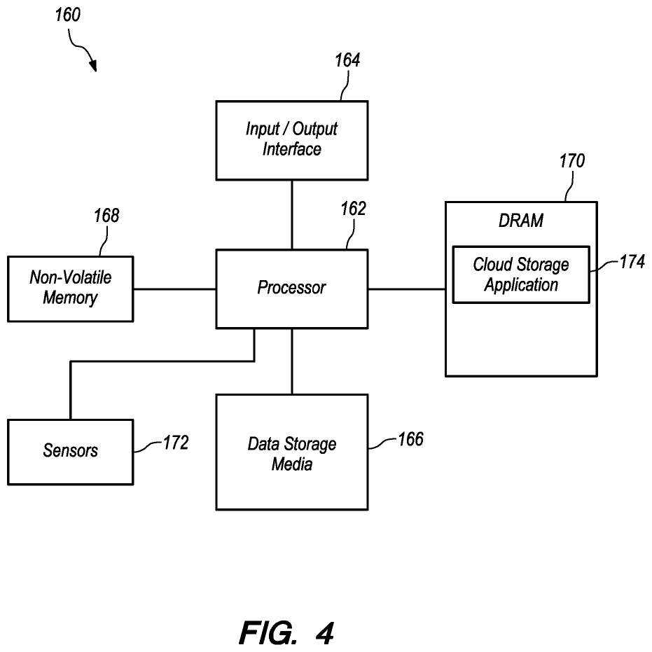

FIG. 1 is a diagram of a virtualization environment 10 including a hypervisor 20 in communication with a cloud storage application 50 for storing application data on physical data storage media 60. The hypervisor 20 runs on a physical computer (see FIG. 4), such as a server. The hypervisor 20 may create and manage one or more virtual machine 30 (guest machine) on the physical computer. The virtual machine 30 may support the operation of an application 31 by providing the functionality of a physical computer and access to the physical resources of the computer. The virtual machine 30 runs independent of any other virtual machines and, therefore, the virtual machine 30 has its own guest operating system 32 that is isolated from the guest operating systems of any other virtual machines running on the same hypervisor 20. Furthermore, the application 31 and one or more additional applications may be executed within the virtual machine 30 with the support of the guest operating system 32. The guest operating system 32 includes a storage disk encryption process 33 that performs the encryption of data received from the application 31 to be stored as data-at-rest in cloud storage 50, 60. For example, the virtual machine 30 may be setup to perform self-encrypting disk (SED) operations on data before storing the encrypted data to a virtual disk 35. The storage disk encryption process 33 may perform or control the actual encryption and any subsequent decryption in support of the application 31.

The application 31 may obtain a unique password 12, either by user input as shown, via internal generation within the application 31, or from the virtual TPM 40 that may be provided by the hypervisor 20. When the application is ready to initiate storage of data to the virtual disk 35, the application 31 may use the TPM driver 34 to access the virtual TPM 40 and request a session key. The virtual TPM 40 may generate a session key and store the session key in a key store 41. The key store 41 may have any suitable data structure but is shown having a plurality of records (illustrated as rows of a table) where each record includes an application (or virtual machine) identifier, the associated password, and the session key. The key store 41 may maintain this information in encrypted or unencrypted form and the information may be stored in a physical trusted platform module (see FIG. 4). In one option, the virtual TPM 40 uses a master key 42 to encrypt the password and used the password to encrypt the session key. The virtual TPM 40 may also share the session key with the application 31 and with the cloud storage application 50 where the application 31 intends to store the data. For example, the cloud storage application 50 may be assigned to receive and store data that is directed to the virtual disk 35.

After the application 31 has received the session key from the virtual TPM 40 and is ready to store data, the application 31 may provide the session key and data (to be stored) to the storage disk encryption process 33 of the guest operating system 32. The storage disk encryption process 33 receives the data and the session key from the application 31 and may then use the session key to encrypt the data. The storage disk encryption process 33 may then send the encrypted data to the cloud storage application 50 for storage on the physical data storage device 60. Optionally, the storage disk encryption process may cache the session key for subsequent use on behalf of the application.

Separately, the virtual TPM 40 establishes a key escrow or other arrangement to provide the session key to the cloud storage application 50 via a secure channel. Subsequently, the cloud storage application 50 may cache and use to the session key to encrypt and/or decrypt the data in-transit to and from the storage disk encryption process 33.

During a data storage (write) operation, the cloud storage application 50 receives data from the application that has already been encrypted with the session key. The cloud storage application 50 may perform further processing of the data in a manner that is transparent to the application 31 or any part of the virtual machine 30. Specifically, the cloud storage application 50 includes an application data decryption/encryption module 51 that decrypts the encrypted data received from the storage disk encryption process 33 using the session key 52 associated with the application 31. The data reduction module 53 may then perform one or more data reduction operations on the decrypted data. Following data reduction, a storage encryption/decryption process 54 may encrypt the compressed data using a storage encryption key 55 before storing the encrypted data on the physical data storage device 60.

Conversely, during a data retrieval (read) operation, the storage encryption/decryption process 54 of the cloud storage application 50 may use the storage encryption key 55 to decrypt the encrypted data read from the physical data storage device 60. The data reduction module 53 may then reverse the previously performed one or more data reduction operations on the decrypted data (i.e., data decompression). Subsequently, the application data decryption/encryption process 51 may use the session key 52 to encrypt the data before transmitting the encrypted data to the virtual machine 30. Accordingly, the application 31 will receive the encrypted data in the same form as the application 31 previously sent for storage. However, the cloud storage application 50 facilitates data reduction to save capacity of the physical data storage 60 while the data is in an encrypted state both during transmission from the application 31 to the cloud storage application 50 and while stored on the physical data storage 60.

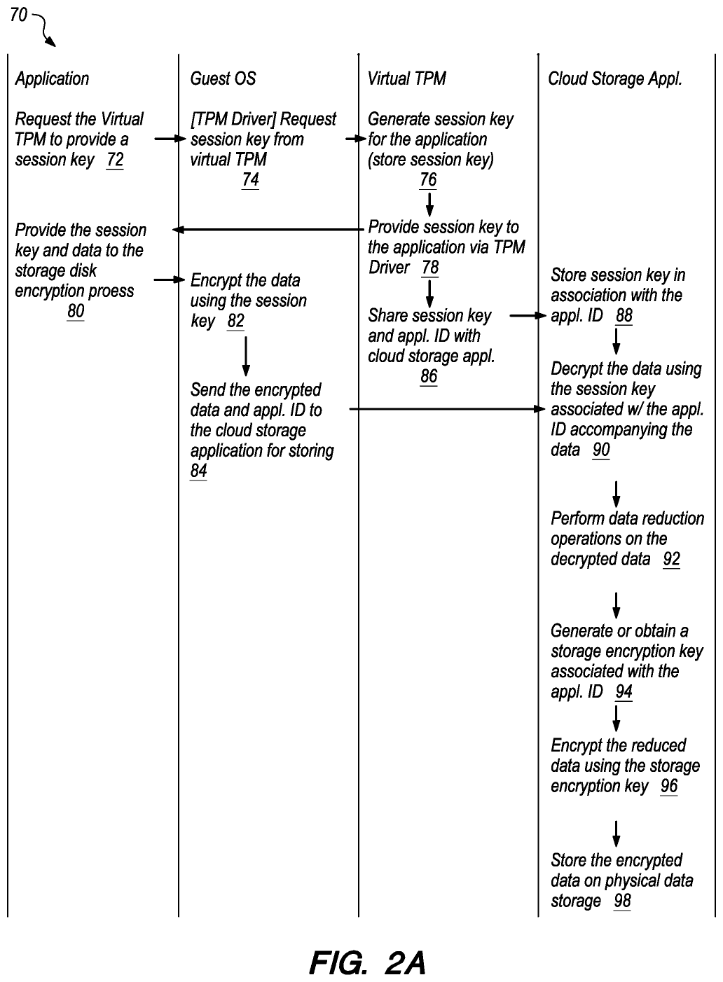

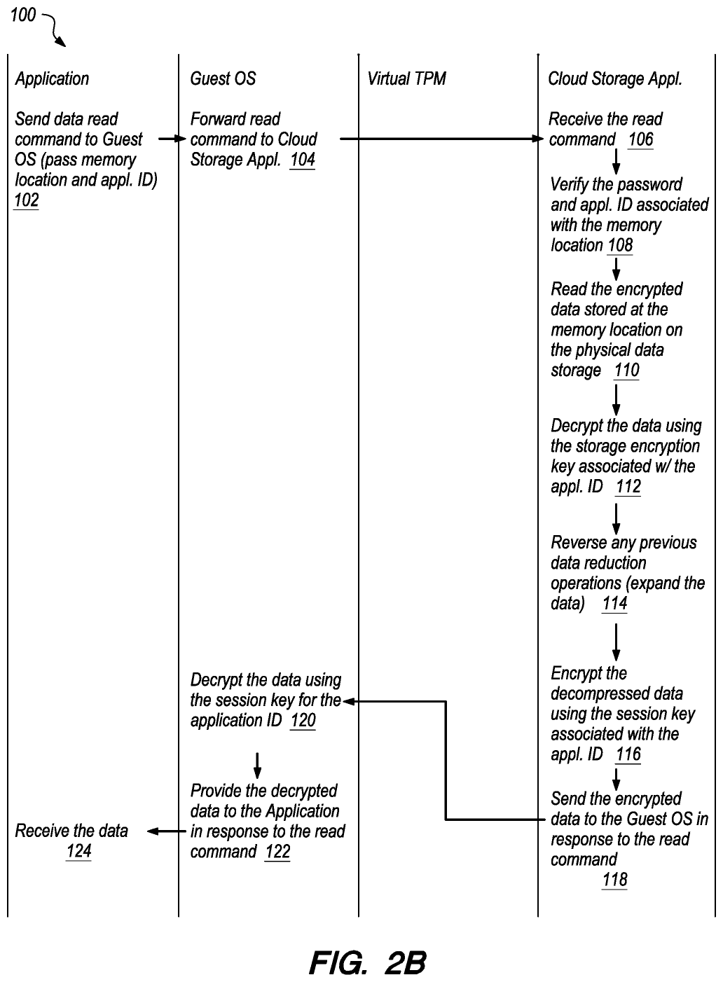

FIG. 2A is a flowchart of a process 70 for storing data from a virtual machine application on physical data storage media with the benefit of both encryption and data reduction operations. In step 72, the application requests that the virtual TPM provide a session key. This request may be triggered by, or be in the form of, an indication that the application is taking steps to write data to storage or may occur during initiation of the application. In step 74, the application uses the TPM driver in the guest operating system to provide the request for the session key to the virtual TPM. In step 76, the virtual TPM receives the request and generates a session key for the application. Typically, the virtual TPM will also store the session key. In step 76, the virtual TPM provides the session key to the application via the TPM driver. It should be noted that, in step 86, the virtual TPM also provides the session key, and perhaps also an application identifier, to the cloud storage application. Such session key is received by the cloud storage application and, in step 88, the cloud storage application stores the session key, perhaps in association with the application identifier.

In step 80, the application provides the session key and data to the storage disk encryption process of the guest operating system. In step 82, the storage disk encryption process (which may be part of the guest operating system) encrypts the data using the session key. In step 84, the guest operating system sends the encrypted data, and optionally also an application identifier, to the cloud storage application for storage and subsequent use. The cloud storage application may then, in step 90, decrypt the encrypted data received from the application using the session key for the application. If the cloud storage application stores data for more than one application, the session key maybe stored in a data structure in association with an application identifier, virtual machine identifier or other process identifier. In step 92, the cloud storage application performs data reduction operations on the decrypted data to obtain compressed data. In step 94, the cloud storage application generates or obtains a storage encryption key, which may be associated with the application identifier. In step 96, the cloud storage application encrypts the compressed data using the storage encryption key. In step 98, the cloud storage application stores the encrypted data on a physical data storage device.

FIG. 2B is a flowchart of a process 100 for reading encrypted data from the physical data storage media and reversing the data reduction operations before returning encrypted data to the virtual machine. In step 102, the application sends a data read command to the guest operating system. The read command includes a memory location and may also include an application identifier for the application. In step 104, the guest operating system forwards the read command to the cloud storage application. In step 106, the cloud storage application receives the read command and, in step 108, may optionally verify the application identifier associated with the memory location or perform any other authentication that may be implemented. In step 110, the cloud storage application reads the encrypted data stored at the memory location on the physical data storage. In step 112, the cloud storage application decrypts the data read from the memory location using the storage encryption key that was previously used to encrypt the data prior to storage. This storage encryption key may be saved in association with the application identifier. In step 114, the cloud storage application reverses any previous data reduction operations that were performed on the data to obtain decompressed data. In step 116, the cloud storage application encrypts the decompressed data using the session key, which may have been stored in a data structure in association with the application identifier. In step 118, the cloud storage application sends the encrypted data to the guest operating system in response to the read command previous received from the guest operating system. In step 120, the storage disk encryption process of the guest operating system decrypts the encrypted data received from the cloud storage application using the session key associated with the application and, in step 122, provides the decrypted data to the application in response to the read command. Finally, in step 124, the application receives that data.

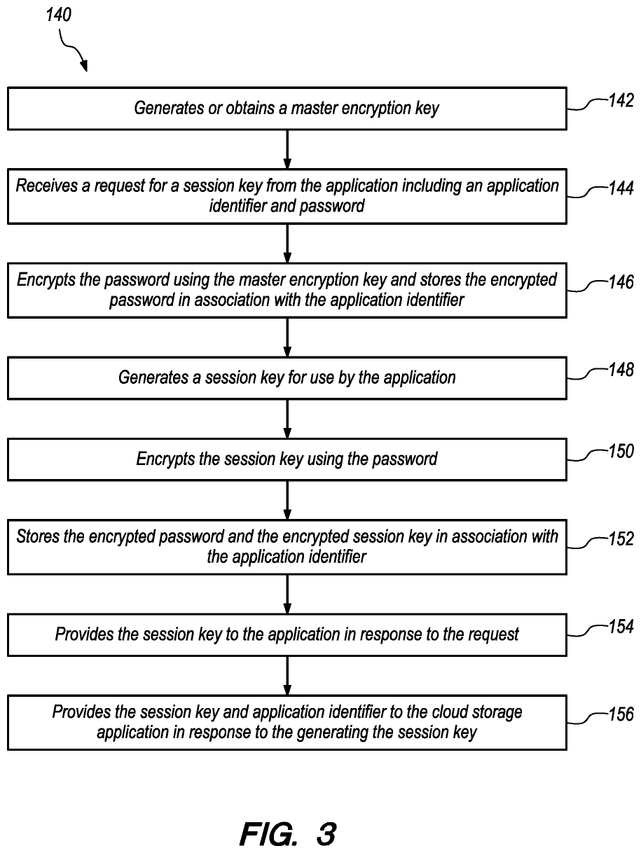

FIG. 3 is a flowchart of a process 140 by which the virtual TPM handles the application identifier, password and session key for each virtual machine application. In step 142, the virtual TPM generates or obtains a master encryption key. In step 144, the virtual TPM receives a request for a session key from the application, which request may include an application identifier and password. In step 146, the virtual TPM encrypts the password, if provided, using the master encryption key and stores the encrypted password in association with the application identifier. In step 148, the virtual TPM generates a session key for use by the application. In step 150, the virtual TPM encrypts the session key using the password, which may be received from the application or generated by the virtual TPM. In step 152, the virtual TPM stores the encrypted password and the encrypted session key, preferably in a data structure that associates the password and session key with the application identifier. In step 154, the virtual TPM provides the session key to the application in response to the request. In step 156, the virtual TPM provides the session key, and perhaps also provides an application identifier, to the cloud storage application in response to generating the session key.

FIG. 4 is a diagram of a data storage device 160 that runs a cloud storage application 174 and stores encrypted data on data storage media 166. The data storage device 160 includes a processor 162 in communication with an input/output interface 164 for communicating with the application and perhaps other entities. The processor 162 is connected to non-volatile memory 168 and a dynamic random-access memory (DRAM) 170 where the cloud storage application 174 may be stored during execution. The processor 162 is also connected to data storage media 166, which may be a storage disk or solid-state drive. The processor 162 may also be connected to one or more sensors 172 for monitoring the operation of the data storage media 166 and/or other parameters.

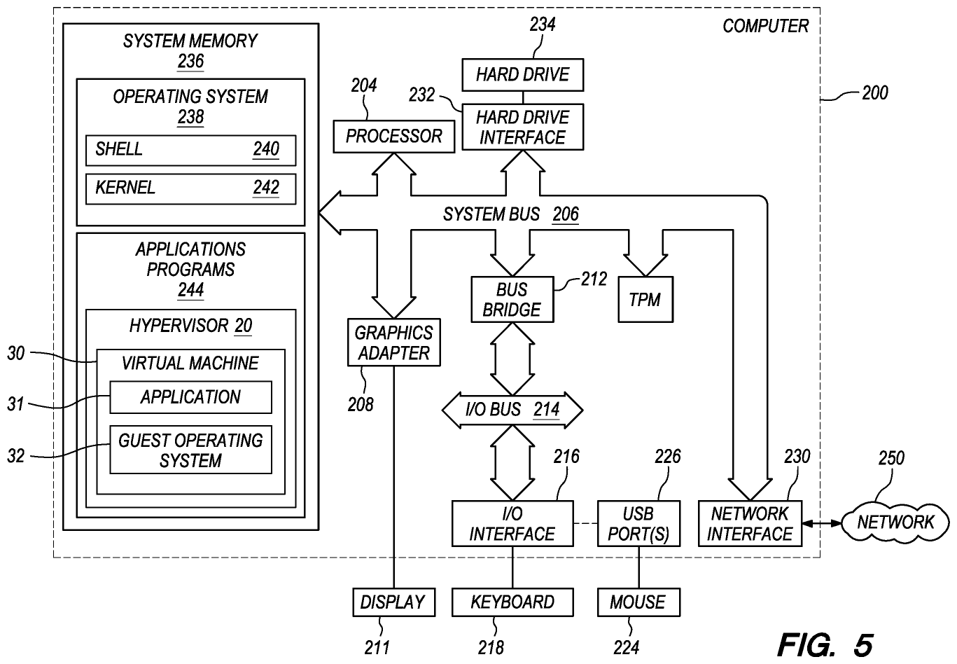

FIG. 5 is a diagram of a computer 200 that is representative of a server running that is suitable for running a hypervisor 20 that supports a virtual machine 30. The computer 200 includes a processor unit 204 that is coupled to a system bus 206. The processor unit 204 may utilize one or more processors, each of which has one or more processor cores. A graphics adapter 208, which drives/supports the display 211, may also be coupled to the system bus 206. The graphics adapter 208 may, for example, include a graphics processing unit (GPU). The system bus 206 is coupled via a bus bridge 212 to an input/output (I/O) bus 214 and an I/O interface 216 is coupled to the I/O bus 214. The I/O interface 216 may facilitate communication with various I/O devices, such as a keyboard 218 (such as a touch screen virtual keyboard) and a USB mouse 224 via USB port(s) 226 (or other type of pointing device, such as a trackpad). As depicted, the computer 200 is able to communicate with other network devices over a network 250 using a network adapter or network interface controller 230. For example, the computer 200 may communicate with one or more computers or data storage controllers that run the cloud storage application and store data in physical data storage.

A hard drive interface 232 is also coupled to the system bus 206 and the hard drive interface 232 interfaces with a hard drive 234. In some embodiments, the hard drive 234 communicates with system memory 236, which is also coupled to the system bus 206. System memory is defined as a lowest level of volatile memory in the computer 200. This volatile memory includes additional higher levels of volatile memory (not shown), including, but not limited to, cache memory, registers and buffers. Data that populates the system memory 236 includes the operating system (OS) 238 and application programs 244.

The computer 200 further includes a physical trusted platform module (TPM) 260 connected to the system bus. The physical TPM 260 may securely store one or more encryption key and other data received from the virtual TPM that is part of the hypervisor. The hardware elements depicted in the computer 200 are not intended to be exhaustive, but rather are representative. For instance, the computer 200 may include non-volatile memory and the like.

The operating system 238 includes a shell 240 for providing transparent user access to resources such as application programs 244. Generally, the shell 240 is a program that provides an interpreter and an interface between the user and the operating system. More specifically, the shell 240 executes commands that are entered into a command line user interface or from a file. Thus, the shell 240, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. Note that while the shell 240 may be a text-based, line-oriented user interface, embodiments may support other user interface modes, such as graphical, voice, gestural, etc.

As depicted, the operating system 238 also includes the kernel 242, which includes lower levels of functionality for the operating system 238, including providing essential services required by other parts of the operating system 238 and application programs 244. Such essential services may include memory management, process and task management, disk management, and mouse and keyboard management. As shown, the computer 200 includes application programs 244 in the system memory of the computer 200, including, without limitation, the hypervisor 20 previously discussed and shown in FIG. 1. The computer 200 may execute and run the hypervisor application 20, as well as the virtual machine 30, the application 31, and the guest operating system 32.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a processor to cause the processor to perform operations comprising:
managing a virtual machine, wherein the virtual machine supports operation of a guest operating system and an application running on the guest operating system;
managing a virtual trusted platform module;
attaching the virtual trusted platform module to the virtual machine; and
causing the virtual trusted platform module to provide a session key to the application and to a cloud storage application that controls data storage on one or more physical data storage devices.

2. The computer program product of claim 1, the operations further comprising:
provisioning the virtual machine; and
assigning the application and guest operating system to the virtual machine.

3. The computer program product of claim 1, the operations further comprising:
causing the virtual trusted platform module to communicate with the cloud storage application over a secure channel using a secure transport protocol that authenticates the cloud storage application.

4. The computer program product of claim 1, the operations further comprising:
causing the virtual trusted platform module to generate the session key; and
causing the virtual trusted platform module to store the session key.

5. The computer program product of claim 4, the operations further comprising:
causing the virtual trusted platform module to encrypt the session key using a password received from the application prior to storing the session key.

6. The computer program product of claim 5, where the virtual trusted platform module stores the session key on a physical trusted platform module.

7. The computer program product of claim 1, the operations further comprising:
causing the virtual trusted platform module to communicate with the virtual machine using a virtual implementation of a physical hardware protocol.

8. The computer program product of claim 1, the operations further comprising:
providing the virtual machine with a virtual disk, wherein the application and guest operating system running in the virtual machine direct data storage operations to the virtual disk; and
causing the virtual disk to emulate the physical data storage device controlled by the cloud storage application, wherein data storage operations directed to the virtual disk are redirected to cloud storage application to be stored on the physical data storage device.

9. The computer program product of claim 1, the operations further comprising:
receiving a password from the application;
encrypting the session key with the password; and
storing the encrypted session key on a physical trusted platform module.

10. The computer program product of claim 1, the operations further comprising:
providing a virtual disk for the virtual machine; and
causing data that is directed from the application to the virtual disk to be forwarded to a cloud storage application for storage on a physical data storage device.

11. A computer program product comprising a non-volatile computer readable medium and non-transitory program instructions embodied therein, the program instructions being configured to be executable by a processor to cause the processor to perform operations comprising:
receiving a session key from a virtual trusted platform module;
receiving first encrypted data from an application running in a virtual machine, wherein the first encrypted data has been encrypted with the session key;
decrypting the first encrypted data received from the application using the session key received from the virtual trusted platform module;
performing one or more data reduction operations on the decrypted data to obtain compressed data;
encrypting the compressed data using a storage encryption key to obtain second encrypted data, wherein the second encrypted data includes fewer bytes than the first encrypted data; and
causing the second encrypted data to be stored on a physical data storage device.

12. The computer program product of claim 11, the operations further comprising:
communicating with the virtual trusted platform module over a secure channel using a secure transport protocol that authenticates the virtual trusted platform module, wherein the session key is received from the virtual trusted platform module over the secure channel.

13. The computer program product of claim 11, the operations further comprising:
receiving a request from the application to read the first encrypted data;
read the second encrypted data stored on the physical data storage device;
decrypt the second encrypted data using the storage encryption key to obtain the compressed data;
decompressing the compressed data to obtain decompressed data;
encrypting the decompressed data using the session key to obtain the first encrypted data; and
sending the first encrypted data to the application in response to the received request.

14. A method, comprising:
managing a virtual machine, wherein the virtual machine supports operation of a guest operating system and an application running on the guest operating system;
managing a virtual trusted platform module;
attaching the virtual trusted platform module to the virtual machine; and
causing the virtual trusted platform module to provide a session key to the application and to a cloud storage application that controls data storage on one or more physical data storage devices.

15. The method of claim 14, the operations further comprising:
provisioning the virtual machine; and
assigning the application and guest operating system to the virtual machine.

16. The method of claim 14, the operations further comprising:
causing the virtual trusted platform module to communicate with the cloud storage application over a secure channel using a secure transport protocol that authenticates the cloud storage application.

17. The method of claim 14, the operations further comprising:
causing the virtual trusted platform module to generate the session key; and
causing the virtual trusted platform module to store the session key.

18. The method of claim 17, the operations further comprising:
causing the virtual trusted platform module to encrypt the session key using a password received from the application prior to storing the session key.

19. The method of claim 18, where the virtual trusted platform module stores the session key on a physical trusted platform module.

20. The method of claim 1, the operations further comprising:
causing the virtual trusted platform module to communicate with the virtual machine using a virtual implementation of a physical hardware protocol.
